(19) United States
(12) Patent Application Publication
(10) Pub. No.: US 2026/0297851 A1
(43) Pub. Date: Oct. 1, 2026

(54) POLYIMIDE FIBRE PAPER

(71) Applicant: DUPONT ELECTRONICS, INC., Wilmington, DE (US)

(72) Inventors: Takayasu NIIMI, Tokai-shi (JP); Mai UCHIYAMA, Tokai-shi (JP); Naofumi YASUDA, Tokai-shi (JP)

(21) Appl. No.: 19/576,097

(22) Filed: Mar. 24, 2026

(30) Foreign Application Priority Data
Mar. 25, 2025 (JP) 2025-50234

(51) Int. Cl. D21H 13/26; D21H 17/07; D21H 17/56

(52) U.S. Cl. CPC D21H 13/26; D21H 17/07; D21H 17/56; D10B 2331/14; D10B 2401/16

(57) ABSTRACT

In a first aspect, a polyimide fibre paper includes a polyimide and has a dielectric loss tangent at 10 GHz of 0.008 or less. In a second aspect, a polyimide fibre paper includes a polyimide including 1,3-bis(4-aminophenoxy)benzene as a polymerisation component.

### FIELD OF THE DISCLOSURE

The present invention relates to a polyimide fibre paper or the like employing a polyimide resin.

### BACKGROUND OF THE DISCLOSURE

A polyimide film is a material having excellent electrical insulation, heat resistance, cold resistance, flame retardancy, chemical resistance, and mechanical properties, and that is utilised across a wide range of fields from aerospace applications to automotive and electronic equipment. In recent years, demand has been growing for polyimide films used as thermal insulation materials in spacecraft requiring a reduction in weight or space saving, as thermal management materials in power devices and heaters operating at higher temperatures, and the like. However, polyimide films do not fully satisfy the requirements of a thermal management material in terms of thermal insulation performance or gas or liquid permeability, and therefore there has been demand for the development of a novel polyimide material having these properties in an improved form.

One example of a polyimide material that satisfies thermal management material properties is a polyimide fibre paper in which a polyimide is formed into fibres and processed into a paper-like form (for example, Patent Document 1).

### CITATION LIST

[Patent Document 1] Japanese Unexamined Patent Publication No. 2023-51247 A.

### SUMMARY

An object of the present invention is to provide a novel polyimide fibre paper.

Another object of the present invention is to provide a polyimide fibre paper capable of efficiently reducing the dielectric loss tangent and/or thermal conductivity.

The present inventors measured the dielectric loss tangent of conventional polyimide fibre papers, such as that of Patent Document 1, and found that the dielectric loss tangent may be high in some cases.

In this context, the present inventors found that the composition of the polyimide constituting the polyimide fibre paper is related to the dielectric loss tangent or thermal conductivity of the polyimide fibre paper. Moreover, the present inventors found that, by using a polyimide employing a diamine having a specific structure, a polyimide fibre paper having an efficiently reduced dielectric loss tangent and/or thermal conductivity may be obtained, and conducted further research, leading to the completion of the present invention.

That is, the present invention relates to the following inventions:
(1) A polyimide fibre paper containing a polyimide (in particular, polyimide fibres) (or formed by containing polyimide fibres as a material), and having a dielectric loss tangent at 10 GHz of 0.008 or less.
(2) A polyimide fibre paper containing a polyimide including at least 1,3-bis(4-aminophenoxy)benzene as a polymerisation component (for example, the polyimide constituting the polyimide fibres contained in the polyimide fibre paper includes at least 1,3-bis(4-aminophenoxy)benzene as a polymerisation component).
(3) The polyimide fibre paper according to (1), wherein the polyimide (for example, the polyimide constituting the polyimide fibres contained in the polyimide fibre paper) contains at least 1,3-bis(4-aminophenoxy)benzene as a polymerisation component.
(4) The polyimide fibre paper according to any of (1) to (3), wherein a proportion of 1,3-bis(4-aminophenoxy)benzene accounting for a total diamine component (which is a polymerisation component of the polyimide constituting the polyimide fibres contained in the polyimide fibre paper) is 50 mol % or more (for example, 55 mol % or more, or 50 mol % or more).
(5) The polyimide fibre paper according to any of (1) to (4), wherein the polyimide (for example, the polyimide constituting the polyimide fibres contained in the polyimide fibre paper) contains 1,3-bis(4-aminophenoxy)benzene and paraphenylenediamine as polymerisation components.
(6) The polyimide fibre paper according to any of (1) to (5), wherein the polyimide (for example, the polyimide constituting the polyimide fibres contained in the polyimide fibre paper) contains, as polymerisation components, 1,3-bis(4-aminophenoxy)benzene and paraphenylenediamine, and an aromatic acid anhydride component containing at least one selected from pyromellitic dianhydride and 3, 3′, 4, 4′-biphenyltetracarboxylic dianhydride.
(7) The polyimide fibre paper according to any of (1) to (6), wherein a polyimide fibre (contained in the polyimide fibre paper) is bound by a polyimide resin.
(8) The polyimide fibre paper according to (7), containing 15 to 35 parts by mass of the polyimide resin relative to 100 parts by mass of the total of the polyimide fibre and polyimide resin.
(9) The polyimide fibre paper according to any of (1) to (8), wherein a relative permittivity is 1.5 or less.
(10) The polyimide fibre paper according to any of (1) to (9), wherein a thickness is 0.1 mm to 0.7 mm.
(11) The polyimide fibre paper according to any of (1) to (10), wherein a tensile strength [value of (tensile strength in MD direction+tensile strength in TD direction)/2] is 0.1 MPa or more.
(12) The polyimide fibre paper according to any of (1) to (11), wherein a thermal conductivity is 0.04 W/m·K or less.

### Effect of the Invention

According to the present invention, it is possible to provide a novel polyimide fibre paper.

According to another aspect of the present invention, it is possible to provide a polyimide fibre paper having an efficiently reduced dielectric loss tangent and/or thermal conductivity. This kind of polyimide fibre paper may reduce a loss of electrical signals in high-frequency bands, and therefore may achieve efficient operation through improved energy efficiency, reduced energy loss, suppression of heat generation, and improved reliability in high-frequency devices. This kind of polyimide fibre paper may also achieve flame retardancy or low outgassing properties. This kind of polyimide fibre paper may be ideally used in applications such as thermal insulation materials for power devices and the like, thermal management materials in electronic equipment, and the like.

According to another aspect of the present invention, it is possible to provide a polyimide fibre paper having high mechanical strength (for example, tensile strength, tensile modulus, or the like).

### BRIEF DESCRIPTION OF THE DRAWINGS

FIG. 1 is an optical micrograph of the polyimide fibre paper of Example 1.

### DETAILED DESCRIPTION

### Polyimide Fibre Paper

The polyimide fibre paper (polyimide paper) of the present invention contains a polyimide. That is, the polyimide fibre paper of the present invention is formed by containing a polyimide as a material. The polyimide fibre paper of the present invention may have a specific dielectric loss tangent.

### [Polyimide]

The polyimide may preferably be a non-thermoplastic polyimide. The polyimide generally contains an aromatic diamine component and an aromatic acid anhydride component as raw materials (defined as polymerisation components).

Examples of the aromatic diamine component include paraphenylenediamine, 4,4′-diaminodiphenyl ether, 3,3′-diaminodiphenyl ether, 1,3-bis(3-aminophenoxy)benzene, 1,3-bis(4-aminophenoxy)benzene, 4,4′-isopropylidenebis [(4-aminophenoxy)benzene], 2,2-bis[4-(4-aminophenoxy)phenyl] propane, m-phenylenediamine, diaminodiphenylpropane (for example, 4,4′-diaminodiphenylpropane, 3,4′-diaminodiphenylpropane, 3,3′-diaminodiphenylpropane, or the like), diaminodiphenylmethane (for example, 4,4′-diaminodiphenylmethane, 3,4′-diaminodiphenylmethane, 3,3′-diaminodiphenylmethane, or the like), benzidine, diaminodiphenylsulphide (for example, 4,4′-diaminodiphenylsulphide, 3,4′-diaminodiphenylsulphide, 3,3′-diaminodiphenylsulphide, or the like), diaminodiphenylsulphone (for example, 4,4′-diaminodiphenylsulphone, 3,4′-diaminodiphenylsulphone, 3,3′-diaminodiphenylsulphone, or the like), 2,6-diaminopyridine, bis-(4-aminophenyl) diethylsilane, 3,3′-dichlorobenzidine, bis-(4-aminophenyl)ethylphosphine oxide, bis-(4-aminophenyl)phenylphosphine oxide, bis-(4-aminophenyl)-N-phenylamine, bis-(4-aminophenyl)-N-methylamine, 1,5-diaminonaphthalene, 3,3′-dimethyl-4,4′-diaminobiphenyl, 3,4′-dimethyl-3′, 4-diaminobiphenyl, 3,3′-dimethoxybenzidine, 2,4-bis(p-β-amino-t-butylphenyl) ether, bis(p-β-amino-t-butylphenyl) ether, p-bis(2-methyl-4-aminopentyl)benzene, p-bis-(1,1-dimethyl-5-aminopentyl)benzene, m-xylylenediamine, p-xylylenediamine, 2,5-diamino-1,3,4-oxadiazole, 2,2-bis(4-aminophenyl) hexafluoropropane, N-(3-aminophenyl)-4-aminobenzamide, 4-aminophenyl-3-aminobenzoate, and the like. These may be used alone or two or more may be used in combination.

Although the reason is unclear, from the standpoint of facilitating the achievement of a low dielectric loss tangent and low thermal conductivity or the like in the polyimide fibre paper, examples of the aromatic diamine component include (I) those having a molecular structure of high symmetry, (II) those having a flexible molecular structure, (III) those having three or more benzene rings, and the like, and it is preferable to contain at least one having one or more of the characteristics (1) to (III), those having two or more of the characteristics (I) to (III) are more preferable, and those having all of the characteristics (I) to (III) are particularly preferable.
(I) Examples of those having a molecular structure of high symmetry include those that are C2 symmetric with respect to the principal axis of the molecule (that is, those having the same molecular structure as before rotation when rotated 180° with respect to the principal axis of the molecule) and the like.
(II) Examples of those having a flexible molecular structure include those having a plurality of benzene rings, where each benzene ring is bonded to the others via an atom (for example, an oxygen atom, a carbon atom, or the like), and the like. In this kind of structure, the number of benzene rings may be, for example, 2 or more (for example, 3 or more or 4 or more), and may be 10 or less (for example, 9 or less, 8 or less, 7 or less, 6 or less, or 5 or less). Furthermore, in this kind of structure, the number of atoms to which the benzene rings are bonded may be 1 or 2 or more (for example, 3 or more, 4 or more, or the like).
(III) In a structure having 3 or more benzene rings, the number of benzene rings may be 3 or more, and may be, for example, 4 or more (for example, 5 or more) and may be 10 or less (for example, 9 or less, 8 or less, 7 or less, or 6 or less).

Note that in the case of any of (I) to (III), it is preferable that two amino groups are bonded (one each) to the two terminal benzene rings. Examples of aromatic diamine components having all of the characteristics (1) to (III) include 1,3-bis(4-aminophenoxy)benzene, 4,4′-isopropylidenebis [(4-aminophenoxy)benzene], or the like.

Note that for aromatic diamine components having characteristic (II) in particular, it was expected that the mechanical strength of the polyimide fibre paper will be lower due to the flexible structure; however, obtaining a polyimide fibre paper having high mechanical strength was unexpected.

In the total aromatic diamine component, from the standpoint of facilitating the achievement of a low dielectric loss tangent, low thermal conductivity, and high mechanical strength (for example, high tensile strength, high tensile modulus, or the like) or the like in the polyimide fibre paper, the proportion of aromatic diamines having one or more of the characteristics (I) to (III) may be selected from a range of about 50 mol % or more (for example, 50 to 75 mol %), and may be, for example, 53 mol % or more (for example, 53 to 72 mol %), and preferably 55 mol % or more (for example, 55 to 70 mol %, or 60 to 70 mol %).

When the aromatic diamine component contains 1,3-bis(4-aminophenoxy)benzene, from the standpoint of facilitating the achievement of a low dielectric loss tangent, low thermal conductivity, and high mechanical strength (for example, high tensile strength, high tensile modulus, or the like) or the like in the polyimide fibre paper, the proportion of 1,3-bis(4-aminophenoxy)benzene in the total aromatic diamine component may be selected from a range of about 50 mol % or more (for example, 50 to 75 mol %), and may be, for example, 53 mol % or more (for example, 53 to 72 mol %), and preferably 55 mol % or more (for example, 55 to 70 mol %, or 60 to 70 mol %). Note that obtaining higher mechanical strength (for example, high tensile strength or high tensile modulus) by using 1,3-bis(4-aminophenoxy)benzene was unexpected.

From the standpoint of facilitating the achievement of a low dielectric loss tangent, low thermal conductivity, and high mechanical strength (for example, high tensile strength or high tensile modulus) or the like in the polyimide fibre paper, the aromatic diamine component may contain paraphenylenediamine and 1,3-bis(4-aminophenoxy)benzene.

When the aromatic diamine component contains paraphenylenediamine and 1,3-bis(4-aminophenoxy)benzene, a molar ratio of paraphenylenediamine and 1,3-bis(4-aminophenoxy)benzene may be, for example, about 50/50 to 25/70 (for example, 47/53 to 28/72), and preferably about 45/55 to 30/70 (for example, 42/58 to 37/63).

Examples of the aromatic acid anhydride component (aromatic tetracarboxylic acid component) include pyromellitic dianhydride, 3,3′,4,4′-biphenyltetracarboxylic dianhydride, 2, 3′, 3, 4′-biphenyltetracarboxylic dianhydride, 4,4′-oxydiphthalic anhydride, 3,3′,4,4′-benzophenonetetracarboxylic dianhydride, 2,3,6, 7-naphthalenedicarboxylic dianhydride, 2,2-bis(3,4-dicarboxyphenyl) ether, pyridine-2, 3,5,6-tetracarboxylic dianhydride, naphthalenetetracarboxylic dianhydride (for example, 1,2,4,5-naphthalenetetracarboxylic dianhydride, 1,4,5,8-naphthalenetetracarboxylic dianhydride, 1,4,5,8-decahydronaphthalenetetracarboxylic dianhydride, 4, 8-dimethyl-1,2, 5,6-hexahydronaphthalenetetracarboxylic dianhydride, 2,6-dichloro-1, 4, 5,8-naphthalenetetracarboxylic dianhydride, 2,7-dichloro-1, 4, 5, 8-naphthalenetetracarboxylic dianhydride, and 2, 3,6,7-tetrachloro-1, 4,5,8-naphthalenetetracarboxylic dianhydride), 1,8, 9,10-phenanthrenetetracarboxylic dianhydride, 2,2-bis(2,3-dicarboxyphenyl) propane dianhydride, 1,1-bis(3, 4-dicarboxyphenyl) ethane dianhydride, 1,1-bis(2,3-dicarboxyphenyl) ethane dianhydride, bis(2,3-dicarboxyphenyl) methane dianhydride, bis(3,4-dicarboxyphenyl) methane dianhydride, bis(3,4-dicarboxyphenyl) sulphone dianhydride, benzene-1,2, 3,4-tetracarboxylic dianhydride, 3,4, 3′, 4′-benzophenonetetracarboxylic dianhydride, and the like, and preferred examples include pyromellitic dianhydride, 3,3′,4,4′-biphenyltetracarboxylic dianhydride, and the like. These may be used alone or two or more may be used in combination.

Note that the aromatic acid anhydride component may have one or more of the characteristics (I) to (III) described above for the aromatic diamine component.

From the standpoint of facilitating the achievement of a low dielectric loss tangent, low thermal conductivity, and high mechanical strength (for example, high tensile strength, high tensile modulus, or the like) or the like in the polyimide fibre paper, in combination with the aromatic diamine component described above, the aromatic acid anhydride component preferably contains at least one selected from pyromellitic dianhydride and 3,3′,4,4′-biphenyltetracarboxylic dianhydride, and more preferably contains both pyromellitic dianhydride and 3,3′,4,4′-biphenyltetracarboxylic dianhydride.

When the aromatic acid anhydride component contains at least one selected from pyromellitic dianhydride and 3,3′,4,4′-biphenyltetracarboxylic dianhydride, the proportion of the at least one selected from pyromellitic dianhydride and 3, 3′,4,4′-biphenyltetracarboxylic dianhydride relative to the total aromatic acid anhydride component (or total acid anhydride component) may be selected from a range of about 20 mol % or more (for example, 25 to 100 mol %), and may be, for example, 30 mol % or more (for example, 40 mol % or more), and preferably 50 mol % or more (for example, 55 mol % or more).

When the aromatic acid anhydride component contains pyromellitic dianhydride and 3,3′,4,4′-biphenyltetracarboxylic dianhydride, a molar ratio of pyromellitic dianhydride and 3,3′, 4, 4′-biphenyltetracarboxylic dianhydride may be, for example, about 25/75 to 65/35 (for example, 30/70 to 60/40), and preferably about 33/67 to 57/43 (for example, 35/65 to 55/45).

The raw material components of the polyimide (polymerisation component, diamine component, and acid anhydride component) may contain other polymerisation components (for example, other acid anhydride components, other diamine components) in addition to the foregoing aromatic acid anhydride component and aromatic diamine component, to the extent that the effects of the present invention are not impaired. Examples of other diamine components (non-aromatic diamine components) include diaminoadamantanes (for example, 1,3-diaminoadamantane, 3,3′-diamino-1,1′-diaminoadamantane, 3,3′-diaminomethyl-1, 1′-diadamantane, and the like), diaminoalkanes (for example, hexamethylenediamine, heptamethylenediamine, octamethylenediamine, nonamethylenediamine, decamethylenediamine, 3-methylheptamethylenediamine, 4,4′-dimethylheptamethylenediamine, 2, 11-diaminododecane, 2,2-dimethylpropylenediamine, 3-methoxyhexaethylenediamine, 2,5-dimethylhexamethylenediamine, 2,5-dimethylheptamethylenediamine, 5-methylnonamethylenediamine, 1,4-diaminocyclohexane, 1,12-diaminooctadecane, and the like), 1,2-bis(3-aminopropoxy) ethane, 2,5-diamino-1,3,4-oxadiazole, 2,2-bis(4-aminophenyl) hexafluoropropane, N-(3-aminophenyl)-4-aminobenzamide, 4-aminophenyl-3-aminobenzoate, and the like. These may be used alone or two or more may be used in combination.

Note that when the polymerisation component contains another polymerisation component (another diamine component or the like), a proportion of the other polymerisation component relative to the total polymerisation component may be a small ratio; for example, it may be 20 mol % or less (for example 15 mol % or less, 10 mol % or less, 5 mol % or less, 3 mol % or less, or 1 mol % or less).

The polyimide fibre paper may contain an optional component other than a polyimide. That is, the polyimide fibre paper may be formed by containing an optional component other than a polyimide as a material. Note that the optional component may be singular or there may be two or more. The optional component may be a component that may generally be contained in a polyimide fibre paper, and may be a component described below (a binder, a dispersant, a defoamer, a thickener, a component derived therefrom, or the like) that is used in the production of a polyimide fibre paper.

The polyimide fibre paper often satisfies at least one of the physical property values described below, and may typically satisfy at least the dielectric loss tangent (in particular, the dielectric loss tangent and one or two or more physical property values other than dielectric loss tangent). Note that the physical property values described below may be effectively satisfied by, for example, the composition of the polyimide, the thickness of the fibre paper, a combination thereof (selection and adjustment), or the like.

From the standpoint of dielectric properties or the like, the dielectric loss tangent of the polyimide fibre paper at 10 GHz may be selected from a range of about 0.01 or less (for example, 0.0095 or less), and may be preferably about 0.009 or less (for example, 0.0085 or less), and more preferably about 0.008 or less (for example, 0.007 or less or 0.006 or less).

The dielectric loss tangent of the polyimide fibre paper at 10 GHZ (lower limit of dielectric loss tangent) is not particularly limited, but may be selected from a range of about 0.001 or less (for example, 0.0015 or less), and may be about 0.0018 or more (for example, 0.002 or more), and preferably about 0.0025 or more (for example, 0.003 or more, 0.0035 or more, 0.0038 or more, or 0.004 or more).

The range of the dielectric loss tangent of the polyimide fibre paper at 10 GHz may be selected by combining these ranges (upper limit and lower limit) as appropriate (for example, 0.001 to 0.01 or the like; the same applies to the ranges described below).

Specific examples of the dielectric loss tangent of the polyimide fibre paper at 10 GHz include 0.001 to 0.009, preferably 0.001 to 0.008, or the like.

Note that the method of measuring the dielectric loss tangent is not particularly limited, and a known method (for example, SPDR method or the like) may be used. The dielectric loss tangent may be measured, for example, by the method described in the examples below.

From the standpoint of dielectric properties or the like, a relative permittivity of the polyimide fibre paper at 10 GHz may be selected from a range of about 1 or more (for example, 1.1 or more), and may be preferably 1.2 or more (for example, 1.3 or more).

From the standpoint of dielectric properties or the like, the relative permittivity of the polyimide fibre paper at 10 GHZ (upper limit of relative permittivity) may be selected from a range of about 1.9 or less (for example, 1.8 or less), and may be preferably 1.7 or less (for example, 1.6 or less), and more preferably about 1.5 or less (for example, 1.4 or less).

The range of the relative permittivity of the polyimide fibre paper at 10 GHz may be selected by combining these ranges (upper limit and lower limit) as appropriate (for example, 1 to 1.9 or the like).

Note that the method of measuring relative permittivity is not particularly limited, and a known method (for example, SPDR method or the like) may be used. The relative permittivity may be measured, for example, by the method described in the examples below.

A thermal conductivity of the polyimide fibre paper may be selected from a range of about 0.05 W/m·K or less (for example, 0.045 W/m·K or less), and may be preferably about 0.04 W/m·K or less (for example, 0.035 W/m·K or less), and more preferably about 0.035 W/m·K or less (for example, 0.03 W/m·K or less).

The thermal conductivity (lower limit of thermal conductivity) of the polyimide fibre paper is not particularly limited, but may be selected from a range of about 0.001 W/m·K or more (for example, 0.002 W/m·K or more), and may be 0.003 W/m·K or more (for example, 0.004 W/m·K or more), preferably 0.005 W/m·K or more (for example, 0.006 W/m·K or more), and more preferably 0.007 W/m·K or more (for example, 0.008 W/m·K or more, 0.009 W/m·K or more, or 0.01 W/m·K or more).

The range of thermal conductivity of the polyimide fibre paper may be selected by combining these ranges (upper limit and lower limit) as appropriate (for example, 0.01 to 0.05 W/m·K or the like).

Note that the method of measuring thermal conductivity is not particularly limited, and a known method (for example, JIS K 7161 or the like) may be used. The thermal conductivity may be measured, for example, by the method described in the examples below.

A tensile strength of the polyimide fibre paper may be 0.01 MPa or more (for example, 0.02 MPa or more), and may be preferably 0.03 MPa or more (for example, 0.04 MPa or more), more preferably 0.05 MPa or more (for example, 0.06 MPa or more), and particularly preferably 0.07 MPa or more (for example, 0.08 MPa or more, 0.09 MPa or more, or 0.1 MPa or more). Note that the tensile strength may be an average value of a tensile strength in an MD direction (machine direction, vertical direction, length direction, longitudinal direction, and direction perpendicular to the width direction [TD direction]) and a tensile strength in the TD direction (width direction, horizontal direction, right-angle direction, and direction perpendicular to the longitudinal direction [MD direction]), and may be a value of (tensile strength in MD direction+tensile strength in TD direction)/2. The polyimide fibre paper of the present invention may efficiently reduce the dielectric loss tangent and/or thermal conductivity while having high tensile strength.

The tensile strength of the polyimide fibre paper [upper limit of the value of (tensile strength in MD direction+tensile strength in TD direction)/2] is not particularly limited, but may be selected from a range of about 1 MPa or less (for example 0.9 MPa or less), and may be 0.8 MPa or less (for example, 0.7 MPa or less), preferably 0.6 MPa or less (for example, 0.5 MPa or less), and particularly preferably 0.4 MPa or less (for example, 0.3 MPa or less or 0.2 MPa or less).

The range of tensile strength of the polyimide fibre paper [value of (tensile strength in MD direction+tensile strength in TD direction)/2] may be selected by combining these ranges (upper limit and lower limit) as appropriate (for example, 0.05 to 0.2 MPa or the like).

Note that the method of measuring tensile strength is not particularly limited, and a known method (for example, JIS K 7161 or the like) may be used. The tensile strength may be measured, for example, by the method described in the examples below.

A tensile modulus of the polyimide fibre paper [value of (tensile modulus in MD direction+tensile modulus in TD direction)/2] may be 0.15 GPa or more (for example, 0.16 GPa or more), and may be preferably 0.17 GPa or more (for example 0.19 GPa or more), more preferably 0.2 GPa or more (for example, 0.21 GPa or more), and particularly preferably 0.22 GPa or more (for example, 0.23 GPa or more, 0.24 GPa or more, or 0.25 GPa or more). The polyimide fibre paper of the present invention may efficiently reduce the dielectric loss tangent and/or thermal conductivity while having a high tensile modulus.

The tensile modulus of the polyimide fibre paper [value of (tensile modulus in MD direction+tensile modulus in TD direction)/2] (upper limit of tensile modulus) is not particularly limited, but may be selected from a range of about 0.5 GPa or less (for example, 0.49 GPa or less), and may be 0.48 GPa or less (for example, 0.46 GPa or less), preferably 0.45 GPa or less (for example, 0.42 GPa or less), and particularly preferably 0.4 GPa or less (for example, 0.38 GPa or less or 0.36 GPa or less).

The range of tensile modulus of the polyimide fibre paper [value of (tensile modulus in MD direction+tensile modulus in TD direction)/2] may be selected by combining these ranges (upper limit and lower limit) as appropriate (for example, 0.15 to 0.5 GPa or the like).

Note that the method of measuring tensile modulus is not particularly limited, and a known method (for example, JIS K 7161 or the like) may be used. The tensile strength may be measured, for example, by the method described in the examples below.

From the standpoint of a low dielectric constant or the like, a porosity of the polyimide fibre paper may be, for example, about 70% or more (for example, 74% or more), preferably about 75% or more (for example, 77% or more), and more preferably about 78% or more (for example, 80% or more).

From the standpoint of low outgassing properties or the like, the porosity of the polyimide fibre paper (upper limit of porosity) may be, for example, 97% or less (for example, 95% or less), preferably 94% or less (for example, 93% or less), and more preferably 92% or less (for example, 90% or less).

Note that the range may be selected by combining these ranges (upper limit and lower limit) as appropriate (for example, 70 to 97% or the like).

Note that the method of measuring porosity is not particularly limited, and a known method (for example, Archimedes method, mercury porosimetry, gravimetric porosimetry, or the like) may be used. Porosity may be determined by rounding the value obtained using the following formula to the first decimal place, according to, for example, the thickness of the polyimide fibre paper, the paper weight of the polyimide fibre paper, and the density of the polyimide fibres used as the raw material for the polyimide fibre paper (hereinafter also referred to as ‘raw material density’).

$$Porosity ( \% ) = [ 1 - ( paper weight / thickness / raw material density ) ] \times 100$$

Note that the method of measuring the paper weight is not particularly limited, and a known method may be used; for example, it may be measured by the method described in the examples below.

A thickness of the polyimide fibre paper may be selected as appropriate depending on the application or the like, but may be, for example, about 300 μm or more (for example, 320 μm or more), preferably about 330 μm or more (for example, 340 μm or more), and more preferably about 350 μm or more (for example, 360 μm or more), and may be about 370 μm or more (for example, 380 μm or more, 390 μm or more, or 400 μm or more).

The (upper limit) of the thickness of this kind of polyimide fibre paper is not particularly limited, but may be, for example, about 1 mm or less (for example, 900 μm or less), preferably about 850 μm or less (for example, 800 μm or less), and more preferably about 750 μm or less (for example, 700 μm or less), and may be particularly preferably 650 μm or less (for example, 600 μm or less, 550 μm or less, or 500 μm or less).

Specific examples of the thickness of the polyimide fibre paper include, for example, 300 μm to 1 mm, preferably 350 μm to 550 μm, and more preferably 350 μm to 450 μm, or the like.

Note that the method of measuring thickness is not particularly limited, and a known method may be used. The thickness may be measured, for example, by the method described in the examples below.

The polyimide fibre paper may contain a polyimide, generally in fibre form. That is, the polyimide fibre paper may contain a polyimide fibre. Furthermore, the polyimide fibre paper may contain a polyimide in resin form (or a form in which a portion or all of the resin has been cured).

The polyimide constituting the polyimide fibre may be any of the examples described above, and it is particularly preferable to contain at least an aromatic diamine component having all of the characteristics (I) to (III) described above (for example, 1,3-bis(4-aminophenoxy)benzene) as a polymerisation component of the polyimide constituting the polyimide fibre.

In the polyimide fibre paper, the polyimide in fibre form may be a polyimide fibre described later (or fibre derived therefrom). Furthermore, the polyimide in resin form may be derived from a polyimide precursor dispersed in a temporary-bonding paper described later, and may be one in which the polyimide precursor has been imidised. The polymerisation component of the polyimide precursor may be the same as the polyimide described above, and may contain an aromatic diamine component having all of the characteristics (I) to (III) described above (for example, 1,3-bis(4-aminophenoxy)benzene).

The polyimide fibre paper may be in a form in which the polyimide in fibre form (polyimide fibre) is bound by a polyimide resin. For example, the polyimide fibres may be in a form in which they are bound to one another by a structural portion containing a polyimide resin (for example, a sugar syrup-like structural portion).

In the polyimide fibre paper, a proportion of the polyimide resin, relative to 100 parts by mass of the total amount of polyimide fibres and polyimide resin, may be, for example, 10 mass % or more, and preferably 15 mass % or more (for example, 15 to 50 mass %, 15 to 40 mass %, 15 to 35 mass %, or the like).

In the polyimide fibre paper, a proportion of the polyimide fibre, relative to 100 parts by mass of the total amount of polyimide fibres and polyimide resin, may be, for example, 30 mass % or more, and preferably 40 mass % or more (for example, 50 to 90 mass %, 55 to 85 mass %, 60 to 80 mass %, or the like).

Note that the proportion of the polyimide resin and the proportion of the polyimide fibre, relative to 100 parts by mass of the total amount of polyimide fibres and polyimide resin, may be calculated from the amount of each additive.

### [Method of Producing Polyimide Fibre Paper]

A method of producing the polyimide fibre paper is described below. In the production of the polyimide fibre paper, it is preferable to use a polyimide fibre (in particular, short polyimide fibres) as a raw material.

From the standpoint of thermal conductivity, dielectric properties, mechanical strength (for example, tensile strength or the like), or the like of the polyimide fibre paper, a fibre diameter of (a single fibre of) the polyimide fibres may be, for example, 30 μm or more, and may be preferably about 40 μm or more (for example, 43 μm or more), and more preferably about 45 μm or more (for example, 50 μm or more).

From the standpoint of thermal conductivity, dielectric properties, mechanical strength (for example, tensile strength or the like), or the like of the polyimide fibre paper, the fibre diameter of (a single fibre of) the polyimide fibres may be, for example, 80 μm or less, and may be preferably about 70 μm or less (for example, 65 μm or less), and more preferably about 60 μm or less (for example, 55 μm or less).

Note that the method of measuring the fibre diameter is not particularly limited, and a known method (for example, optical microscopy, laser diffraction, or the like) may be used. The fibre diameter may be measured, for example, by the method described in the examples below.

From the standpoint of thermal conductivity, dielectric properties, mechanical strength (for example, tensile strength or the like), or the like of the polyimide fibre paper, a fibre length of (a single fibre of) the polyimide fibres may be, for example, 0.15 mm or more, and may be preferably about 1 mm or more (for example, 1.5 mm or more), and more preferably about 2 mm or more (for example, 2.2 mm or more).

From the standpoint of thermal conductivity, dielectric properties, mechanical strength (for example, tensile strength or the like), or the like of the polyimide fibre paper, the fibre length of (a single fibre of) the polyimide fibres may be, for example, 5 mm or less, and may be preferably about 4 mm or less (for example, 3.5 mm or less), and more preferably 3 mm or less (for example, 2.5 mm or less).

Note that the method of measuring fibre length is not particularly limited, and a known method (for example, JIS P 8226 or the like) may be used. The fibre length may be measured, for example, by the method described in the examples below.

A commercially available product may be used as is as the polyimide fibre, or a commercially available product that has been adjusted as appropriate may be used, and preferably, a product produced employing a polyimide film may be used.

The method for producing polyimide fibres from a polyimide film is not particularly limited, and a known method may be used. Note that a commercially available product may be used as the polyimide film, and a product produced using a conventionally known method may be used.

The method for producing the polyimide fibre paper using the polyimide fibre is not particularly limited, and a known method may be used; for example, the methods described in Japanese Unexamined Patent Publication No. 2019-35157 A, Japanese Unexamined Patent Publication No. 2023-51247 A, or the like may be used. The following describes typical methods for the polyimide fibre paper.

First, polyimide fibres are shaved from the polyimide film. Shaving of the polyimide fibres is performed by, for example, rotating a roll-shaped polyimide film and applying a blade to a side surface of the rotating roll. A width of the polyimide fibres shaved is adjusted by adjusting the thickness of the polyimide film constituting the roll or the fineness of the tip of the blade performing the shaving. Short polyimide fibres may be obtained by cutting a bundle of polyimide fibres obtained by shaving. The fibre length may be adjusted by cutting.

Next, the polyimide fibres are employed to form a temporary-bonding paper. In the formation of the temporary-bonding paper, paper making is carried out by employing a slurry in which polyimide fibres and a binder are mixed. The binder is not particularly limited, and a known binder may be used; for example, a water-soluble polymer (for example, polyvinyl alcohol or the like) may be used. The type of polyvinyl alcohol is not particularly limited, and a commercially available product may be used. Note that the form of the water-soluble polymer is preferably fibrous, powdery, or the like.

The method of paper making is preferably wet paper making, and sheet formation may be carried out by spreading thin and drying a slurry containing the polyimide fibres, the binder, and water. The slurry may contain other components other than the polyimide fibres and the binder. Components conventionally used in paper making may be used as the other components, and these are not particularly limited, but examples thereof include dispersants (for example, water-soluble polyurethane resins or the like), defoamers (for example, urethane-based defoamers or the like), thickeners (for example, polyacrylamide-based thickeners or the like), or the like. The other component may be singular or two or more may be used.

The method of producing the slurry is not particularly limited; for example, a mixture of the polyimide fibres, the binder, water, and another component may be stirred using a mixer or the like. Note that a dispersant, a defoamer, and a thickener may be added and stirred into the slurry containing the polyimide fibres, the binder, and water. The order of adding the dispersant, the defoamer, and the thickener is not particularly limited. Furthermore, it is preferable that the dispersant, the defoamer, and the thickener are each added in the form of an aqueous solution or an aqueous dispersion.

A sheet may be formed by employing a known wire (paper making frame) used in the production of paper to spread the slurry thin and dry it. A known method may be used as the method of forming the sheet. After the sheet is formed, dewatering is carried out in accordance with a conventional method.

After dewatering, the resulting sheet is dried. The method of drying is not particularly limited, and a known method may be used. This drying may allow the binder to be fused (heat-fused), and a temporary-bonding paper may be obtained.

A polyimide precursor may be dispersed in the resulting temporary-bonding paper. The polyimide precursor may be a polyamic acid solution described later, or may be a polyamide-imide. Note that the polyimide precursor may be one in which the aromatic diamine component and aromatic acid anhydride component described above are contained as polymerisation components. The polymerisation components of the polyimide precursor may be the same as the polyimide constituting the polyimide fibre, or may be different.

A known method may be used as the method of dispersing the polyimide precursor in the temporary-bonding paper; for example, the temporary-bonding paper may be impregnated with a dispersion (solution, aqueous solution, or the like) of the polyimide precursor, after which the solvent of the dispersion of the polyimide precursor may then be removed by heating. Note that the heating conditions (heating temperature and duration) need only be such that the solvent of the dispersion of the polyimide precursor [for example, water, an alcohol-based solvent (for example, N,N-dimethylaminoethanol or the like), an ester-based solvent (for example, triethyl orthoformate or the like), or the like] may be removed. The heating temperature may be, for example, 100 to 120° C. or the like. The heating time is not particularly limited, and may be, for example, 1 to 15 minutes or the like. The heating is preferably carried out under conditions in which imidisation of the polyimide precursor does not occur. After heating, the temporary-bonding paper may be obtained.

The temporary-bonding paper may be further heated to obtain a polyimide fibre paper. Heating may be carried out at a temperature at which both removal of the binder and imidisation of the polyimide precursor may be performed (for example, 350 to 480° C. or the like), or may be a two-stage heating process in which removal of the binder and imidisation of the polyimide precursor are carried out separately. In the case of the two-stage heating process, for example, removal of the binder is carried out at a temperature of 190 to 250° C. or the like, and then imidisation of the polyimide precursor is carried out at a temperature of 350 to 480° C. or the like. Note that the binder need not be completely removed, and a portion thereof may remain. The heating time may be set as appropriate depending on the heating temperature or the like. Heating may also be carried out in a superheated steam furnace, an inert oven, or the like.

The polyimide fibre paper obtained as described above may be further subjected to post-treatment. The post-treatment is not particularly limited, and a conventionally known treatment may be carried out; for example, the polyimide fibre paper may be pressed. The polyimide fibre paper may be further thinned by pressing. The method for pressing is not particularly limited, and a known method may be used.

Note that when producing the polyimide film used as the raw material of the polyimide fibre, production may be carried out by using the following method of production.

The method of producing the polyimide film is not particularly limited, but the following describes a typical method. When obtaining the polyimide film, first, a polyamic acid solution is obtained by polymerising the polymerisation component (component containing the aromatic diamine component and the aromatic acid anhydride component) in an organic solvent.

Specific examples of the organic solvent used in the formation of the polyamic acid solution include sulphoxide-based solvents such as dimethyl sulphoxide, diethyl sulphoxide, and the like; formamide-based solvents such as N,N-dimethylformamide, N,N-diethylformamide, and the like; acetamide-based solvents such as N,N-dimethylacetamide, N,N-diethylacetamide, and the like; pyrrolidone-based solvents such as N-methyl-2-pyrrolidone, N-vinyl-2-pyrrolidone, and the like; phenol-based solvents such as phenol, o-, m-, or p-cresol, xylenol, halogenated phenol, catechol, and the like; aprotic polar solvents such as hexamethylphosphoramide, γ-butyrolactone, and the like; and the like.

These may be used alone or two or more may be used in combination. These may further be used in combination with an aromatic hydrocarbon group such as xylene, toluene, and the like.

The polyamic acid solution may be polymerised by any known method; for example:
(1) a method in which the entire amount of the diamine component (aromatic diamine component) is first placed in a solvent, after which the acid anhydride component (aromatic acid anhydride component) is added in an amount equivalent to the entire amount of the diamine component (aromatic diamine component) and polymerisation is carried out;
(2) a method in which the entire amount of the acid anhydride component (aromatic acid anhydride component) is first placed in a solvent, after which the diamine component (aromatic diamine component) is added in an amount equivalent to the acid anhydride component (aromatic acid anhydride component) and polymerisation is carried out;
(3) a method in which one diamine component (aromatic diamine component) is placed in a solvent, then one acid anhydride component (aromatic acid anhydride component) is mixed in a ratio of 95 to 105 mol % relative to the reaction components for the time necessary for a reaction, after which another aromatic diamine component is added, followed by addition of one more acid anhydride component (aromatic acid anhydride component) such that the amounts of the total diamine component (aromatic diamine component) and total acid anhydride component (aromatic acid anhydride component) are substantially equivalent, and polymerisation is carried out;
(4) a method in which one acid anhydride component (aromatic acid anhydride component) is placed in a solvent, then one diamine component (aromatic diamine component) is mixed in a ratio of 95 to 105 mol % relative to the reaction components for the time necessary for a reaction, after which another acid anhydride component (aromatic acid anhydride component) is added, followed by addition of one more diamine component (aromatic diamine component) such that the amounts of the total diamine component (aromatic diamine component) and total acid anhydride component (aromatic acid anhydride component) are substantially equivalent, and polymerisation is carried out; or
(5) a method in which one diamine component (aromatic diamine component) and an acid anhydride component (aromatic acid anhydride component) are reacted in a solvent such that one is in excess, to prepare a polyamic acid solution (A); separately, another diamine component (aromatic diamine component) and acid anhydride component (aromatic acid anhydride component) are reacted in another solvent such that one is in excess, to prepare a polyamic acid solution (B). The polyamic acid solutions (A) and (B) obtained thereby are mixed to complete polymerisation. A method is given as an example where, at this time, when the polyamic acid solution (A) is adjusted, if the diamine component (aromatic diamine component) is in excess, the acid anhydride component (aromatic acid anhydride component) is used in excess in polyamic acid solution (B); and if the acid anhydride component (aromatic acid anhydride component) is in excess in polyamic acid solution (A), the diamine component (aromatic diamine component) is used in excess in polyamic acid solution (B); polyamic acid solutions (A) and (B) are mixed together and adjusted such that the total diamine component (aromatic diamine component) and total acid anhydride component (aromatic acid anhydride component) used in these reactions are substantially equivalent.

Note that the method of polymerisation is not limited to these, and another known method may be employed.

The acid anhydride component (aromatic acid anhydride component) and the diamine component (aromatic diamine component) constituting the polyamic acid are polymerised in proportions where their respective molar amounts are substantially equal; however, one may be blended in excess of the other within a range of 10 mol %, and preferably 5 mol %.

The polymerisation reaction is preferably carried out while stirring in an organic solvent. The polymerisation temperature is not particularly limited, but the reaction is generally carried out when the internal temperature of the reaction solution is 0 to 80° C. The polymerisation time is not particularly limited, but polymerisation is preferably carried out continuously for 10 minutes to 30 hours. The polymerisation reaction may, if necessary, be split or carried out at varying temperatures. The order of adding both reactants is not particularly limited, but it is preferable to add the aromatic acid anhydride into the aromatic diamine component solution. Vacuum defoaming during the polymerisation reaction is an effective method for producing a high-quality organic solvent solution of polyamic acid. The polymerisation reaction may also be controlled by adding a small amount of an end-capping agent to the aromatic diamines prior to the polymerisation reaction. The end-capping agent is not particularly limited, and a known agent may be used.

The polyamic acid solution thus obtained may generally contain a solid content of 5 to 40 mass %, and preferably 10 to 30 mass %. The viscosity thereof is also not particularly limited, but the value measured by a Brookfield viscometer is generally 10 to 2,000 Pas, and is preferably 100 to 1,000 Pas for stable liquid feeding. Furthermore, the polyamic acid in the organic solvent solution may be partially imidised.

When a polyimide film containing inorganic particles is obtained, the inorganic particles may be contained in the polyamic acid solution. When obtaining the polyamic acid solution containing inorganic particles, the inorganic particles may be added to a pre-polymerised polyamic acid solution, or the polyamic acid solution may be polymerised in the presence of inorganic particles.

Using inorganic particles as a slurry (inorganic particle slurry) dispersed in a solvent (for example, a polar solvent such as N,N-dimethylformamide, N,N-dimethylacetamide, dimethyl sulphoxide, N-methylpyrrolidone, or the like) is preferred to be able to prevent aggregation.

The method of producing the inorganic particle slurry is not particularly limited, and a conventionally known method may be followed. An example of the method of producing the inorganic particle slurry is employing a mixer to mix inorganic particles and a solvent. It is preferable to employ a mixer having high shear force, such as a high-speed dispenser, a homomixer, a ball mill, a Cowles mixer, an agitation-type dispenser, or the like. Wet grinding treatment may also be carried out to reduce the average particle diameter. A bead mill, a sand mill, or the like may be employed for the wet grinding treatment, for example.

A commercially available product in which inorganic particles are pre-dispersed in a solvent may be used as the inorganic particle slurry. The inorganic particle slurry may also contain, if necessary, other organic solvents, compounding agents, or the like.

A concentration of the inorganic particles in the inorganic particle slurry is not particularly limited; examples include 1 to 80 mass %, preferably 1 to 60 mass %, and more preferably 1 to 40 mass %.

From the standpoint of being able to remove the inorganic particles having a prescribed pore size in the polyimide film (for example, inorganic particles having a pore size of 15 μm or more), it is preferable to pass the inorganic particle slurry through a filter having a prescribed pore size (for example, a cut filter having a pore size of 15 μm or less, preferably 13 μm or less, more preferably 11 μm or less, even more preferably 5 μm or less, and particularly preferably 3 μm or less) (to filter the slurry) to be able to suppress aggregation of the inorganic particles.

The material of the filter is not particularly limited, and examples include polymer materials (for example, polyethylene, polypropylene, polytetrafluoroethylene, or the like), metals (for example, stainless steel or the like), and the like.

The amount of inorganic particles added may be selected as appropriate in accordance with the desired content in the polyimide film (for example, such that the amount is 0.03 to 0.8 parts by mass relative to 100 parts by mass of the polyimide when the polyimide is formed).

Next, a method of producing the polyimide film is described. Film formation (production) of the polyimide film may be obtained through, for example, a step (1) of subjecting a polyamic acid solution to a cyclisation reaction to obtain a gel film (converting the polyamic acid or polyamic acid solution into a gel film), and a step (2) of drying (and desolvating) the obtained gel film and subjecting it to heat treatment. Note that drying and imidisation proceed through the drying and heat treatment.

In step (1), the method of subjecting the polyamic acid solution to a cyclisation reaction is not particularly limited, but specific examples include (i) a method in which the polyamic acid solution is cast into a film and thermally dehydrated and cyclised to obtain a gel film (thermal ring-closure method), or (ii) a method in which a catalyst (cyclisation catalyst) and a dehydrating agent (converting agent) are mixed into the polyamic acid solution to chemically cyclise it to produce a gel film, which is then heated to obtain a gel film (chemical ring-closure method); the latter method (chemical ring-closure method) is particularly preferred.

According to the chemical ring-closure method (and further selecting the chemical ring-closure method while selecting polymerisation components as described above), it surprisingly appears that the physical properties (characteristics) required of the polyimide film of the present invention may be efficiently obtained with ease. The chemical ring-closure method is also suitable from the standpoint of mass productivity.

Note that the polyamic acid solution may contain a gelation retarder or the like. The gelation retarder is not particularly limited, and acetylacetone or the like may be used.

Examples of cyclisation catalysts include amines, such as aliphatic tertiary amines (trimethylamine, triethylenediamine, and the like), aromatic tertiary amines (dimethylaniline and the like), heterocyclic tertiary amines (for example, isoquinoline, pyridine, B-picoline, and the like), and the like. These may be used alone or two or more may be mixed and employed. Of these, a heterocyclic tertiary amine such as B-picoline is preferred.

Examples of dehydrating agents include acid anhydrides, such as aliphatic carboxylic acid anhydrides (for example, acetic anhydride, propionic anhydride, butyric anhydride, and the like), aromatic carboxylic acid anhydrides (for example, benzoic anhydride and the like), and the like. These may be used alone or two or more may be mixed and employed. Of these, acetic anhydride and/or benzoic anhydride is preferred, and acetic anhydride is particularly preferred.

The amounts of cyclisation catalyst and dehydrating agent used are not particularly limited, but each may be, for example, about 1 mol or more (for example, 1.5 to 10 mol) relative to 1 mol of amide groups (or carboxyl groups) of the polyamic acid (or polyamide acid).

The gel film may generally be obtained by casting (applying) a polyamic acid solution (in particular, a polyamic acid solution having a cyclisation catalyst and converting agent mixed therein) onto a support and partially drying and curing (imidising) it.

More specifically, a polyamic acid solution is cast onto a support from a slitted die, moulded into a film, heated using heat received from the support, hot air, or a heat source such as an electric heater or the like to cause a ring-closure reaction, and volatile components such as the liberated organic solvent or the like are dried to form a gel film, which is then peeled off from the support.

Here, the gel film must be provided with self-supporting properties in order to be peeled off, but the form of a gel film obtained by the chemical ring-closure method and that obtained by the thermal ring-closure method generally differ significantly. That is, in the chemical ring-closure method, since gelation (conversion) is achieved using a catalyst, a gel film having self-supporting properties and containing a large amount of solvent (a gel film that is flexible, wet, or the like) is obtained, whereas in the thermal ring-closure method, extensive heat treatment is required for gelation (to impart self-supporting properties), resulting in a comparatively rigid gel film (having little residual solvent).

The support is not particularly limited, but examples include a metal (for example, stainless steel) rotating drum, an endless belt, or the like. The temperature of the support is not particularly limited, and may be, for example, 30 to 200° C., preferably 40 to 150° C., and more preferably 50 to 120° C. Note that the temperature of the support may be controlled by (i) a liquid or gaseous heat medium; (ii) radiant heat from an electric heater or the like; or the like.

In step (2), the gel film is dried (desolvated) and subjected to heat treatment. Generally, step (2) may include a step of passing the gel film through a heating furnace (a tenter furnace or the like) while gripping both ends in the width direction to dry it, and then performing heat treatment.

Specifically, the gel film peeled off from the support is not particularly limited, but generally, it may be drawn in the machine direction while the line speed is restricted by a rotating roll. Note that the thickness or the like of the polyimide film may be adjusted by the line speed.

Drawing in the machine direction may be implemented at a prescribed temperature (for example, a temperature of 140° C. or less). A draw ratio (MDX) thereof is generally 1.05 to 1.9 times, preferably 1.1 to 1.6 times, and more preferably 1.1 to 1.5 times (for example, 1.15 to 1.4 times).

When drying, the drying temperature may be, for example, 210° C. or more (for example, 213 to 500° C.), preferably 215° C. or more (for example, 218 to 400° C.), and more preferably 220° C. or more (for example, 220 to 300° C.).

Drying may also be carried out while suppressing uneven drying (variation) in the width direction of the film. For example, drying temperature unevenness in the width direction of the film may be less than 25° C. (for example, 0 to 24° C.), preferably 22° C. or less (for example, 1 to 21° C.), more preferably 20° C. or less (for example, 2 to 19° C.), and particularly 18° C. or less (for example, 3 to 18° C.).

Note that for drying temperature unevenness, it is possible to take multiple measurement points at prescribed intervals (for example, 200 mm) along the width direction of the film, for example, and measure the difference (gap) between the maximum and minimum measured drying temperature values.

The gel film (in particular, a gel film drawn in the machine direction) is dried and then subjected to heat treatment. The heat treatment temperature is not particularly limited, and may be, for example, 200° C. or more (for example, 250 to 600° C.), preferably 300° C. or more, and more preferably 350° C. or more.

After drying, the gel film may be further drawn in the width direction. Drawing in the width direction may be carried out along with the heat treatment.

When drawing in the width direction, a draw ratio (TDX) is, for example, 1.05 to 1.9 times, preferably 1.1 to 1.6 times, and more preferably 1.1 to 1.5 times (for example, 1.15 to 1.4 times).

From the standpoint of thermal conductivity, dielectric properties, mechanical strength (for example, tensile strength or the like), or the like of the polyimide fibre paper, a water absorption rate of the polyimide film may be 0.2% or more (for example, 0.3% or more), and may preferably be 0.4% or more (for example, 0.5% or more or 0.6% or more), more preferably 0.7% or more (for example, 0.75% or more), and particularly preferably 0.8% or more (for example, 0.85% or more or 0.9% or more).

The water absorption rate of the polyimide film is not particularly limited, but from the standpoint of thermal conductivity, dielectric properties, mechanical strength (for example, tensile strength or the like), or the like of the polyimide fibre paper, it may be selected from a range of about 2% or less, and may be preferably 1.7% or less (for example, 1.5% or less).

The range of the water absorption rate of the polyimide film may be selected by combining these ranges (upper limit and lower limit) as appropriate (for example, 0.2 to 2% or the like).

Note that the method of measuring the water absorption rate is not particularly limited, and a known method (for example, JIS K 7209 or the like) may be used. The water absorption rate may be the rate of increase in the weight of the polyimide film after being left to stand in distilled water for one day (for example, after being left to stand at normal temperature for one day), relative to the dry weight of the polyimide film (for example, the weight after heat treatment at 200° C. for one hour), and may be measured by the method described in the examples below.

From the standpoint of thermal conductivity, dielectric properties, mechanical strength (for example, tensile strength or the like), or the like of the polyimide fibre paper, a glass transition temperature (T_{g}) of the polyimide film may be selected from a range of about 330° C. or less (for example, 320° C. or less or 310° C. or less), and may be preferably 300° C. or less (for example, 295° C. or less), more preferably 290° C. or less (for example, 285° C. or less), and particularly preferably 280° C. or less (for example, 275° C. or less, 270° C. or less, 265° C. or less, 260° C. or less, 255° C. or less, or 250° C. or less).

From the standpoint of thermal conductivity, dielectric properties, mechanical strength (for example, tensile strength or the like), or the like of the polyimide fibre paper, the T_{g} (lower limit of T_{g}) of the polyimide film may be selected from a range of about 150° C. or more (for example, 160° C. or more or 170° C. or more), and may be preferably 180° C. or more (for example, 190° C. or more), more preferably 200° C. or more (for example, 210° C. or more), particularly preferably 220° C. or more (for example, 225° C. or more, 230° C. or more, 235° C. or more, 240° C. or more, or 245° C. or more), or the like.

The range of the T_{g} of the polyimide film may be selected by combining these ranges (upper limit and lower limit) as appropriate (for example, 150 to 330° C., 180 to 300° C., or the like).

Note that the method of measuring the T_{g} is not particularly limited, and a known method may be used; for example, the tan δ method (that is, the value at which the peak intensity of tan δ is taken as T_{g}) may be used, and T_{g} may be measured by the method described in the examples below.

From the standpoint of thermal conductivity, dielectric properties, mechanical strength (for example, tensile strength or the like), or the like of the polyimide fibre paper, an imidisation ratio of the polyimide film may be 80% or more (for example, 85% or more), and may preferably be 90% or more (for example, 95% or more), and more preferably 97% or more (for example, 98% or more or 99% or more). Note that the imidisation ratio may be adjusted in the step of producing the polyimide film by adjusting the line speed, drying temperature, or the like.

The upper limit of the imidisation ratio of the polyimide film is not particularly limited, but from the standpoint of thermal conductivity, dielectric properties, mechanical strength (for example, tensile strength or the like), or the like of the polyimide fibre paper, it may be selected from a range of about 100% or less (for example, 99.9% or less, 99.5% or less, or 99% or less).

The range of the imidisation ratio of the polyimide film may be selected by combining these ranges (upper limit and lower limit) as appropriate (for example, 90 to 100% or the like).

Note that the method of measuring the imidisation ratio is not particularly limited, and a known method may be used (for example, Fourier transform infrared spectroscopy or the like); for example, it may be measured by the method described in the examples below.

### Applications of Polyimide Fibre Paper

The polyimide fibre paper of the present invention may be used in a variety of applications; for example, multi-layer insulation (MLI) for spacecraft applications, thermal insulation materials for enclosed spaces, thermal insulation materials for batteries or electronic control units of automobiles (for example, electric vehicles, hybrid vehicles, and the like), and the like.

### EXAMPLES

Next, the present invention will be described in more detail with reference to examples; however, the present invention is not limited in any way by these examples, and many variations are possible within the technical idea of the present invention by a person having ordinary skill in the art.

Each property was evaluated by the following methods.
Relative permittivity

Equipment: Relative permittivity was measured by the cavity resonator method using a network analyser (P5006B Vector Analyser) and a resonator (for measurement at 10 GHZ).
Dielectric loss tangent

Equipment: Dielectric loss tangent was measured by the cavity resonator method using a network analyser (P5006B Vector Analyser) and a resonator (for measurement at 10 GHZ).
Thermal conductivity

Equipment: Thermal conductivity was measured by the steady-state method using a KES-F7 Thermo Labo (trade name, manufactured by Kato Tech Co., Ltd.) . . . .
Tensile strength

The tensile strength of a 15 mm×250 mm test piece was measured by employing a tensile testing machine (tensile/compression testing machine: SVZ-50NA type, weight system: SL-6001 type [trade name, manufactured by Imada-SS Corporation]) set at a 180 mm interval. Note that the tensile strength was measured in both the machine direction (MD) and the width direction (TD), and the value of (MD value+TD value)/2 was calculated.
Tensile modulus

The tensile modulus of a 15 mm×250 mm test piece was measured by employing a tensile testing machine (tensile/compression testing machine: SVZ-50NA type, weight system: SL-6001 type [trade name, manufactured by Imada-SS Corporation]) set at a 180 mm interval. Note that the tensile modulus was measured in both the machine direction (MD) and the width direction (TD) of the film, and the value of (MD value+TD value)/2 was calculated.
Porosity

Porosity was determined by rounding the value determined by the following formula to the first decimal place, based on the thickness, paper weight, and density of the polyimide fibres used as the raw material for the polyimide fibre paper (raw material density).

Porosity (%)=[1−(paper weight/thickness/raw material density)]×100
Paper weight

Three samples measuring 20 cm vertically x 20 cm horizontally were taken and the weight of each sample was measured, and the average of the obtained values was converted to a value per unit area and rounded to the first decimal place.
Thickness

Measured by employing a dial thickness gauge.
Fibre length, fibre diameter

The fibre length and fibre diameter were measured by employing a fibre length distribution analyser (testing instrument: L&W Fibre Tester).
Optical micrographs

The polyimide fibre paper was observed using an optical microscope (VK-X3000).
Water absorption rate

The polyimide film was left to stand in distilled water at normal temperature for one day, and the water absorption rate was evaluated according to the percentage increase in weight relative to the dry weight. Specifically, a film cut into a circle 6 cm in diameter was subjected to heat treatment at 200° C. for one hour, and the weight thereafter (W0) was measured as the dry weight, then the weight (W1) of the film after being left to stand in distilled water at normal temperature for one day to absorb water was measured, and the water absorption rate was calculated using the following formula.

$$Water absorption rate ( \% ) = ( W 1 - W 0 ) / W 0 \times 100$$

Glass transition temperature

Measurements were carried out using a viscoelastic analyser DMS EXSTER 6100, manufactured by Hitachi High-Tech Science Corporation, under the following conditions: measurement temperature range: 25 to 500° C., heating rate: 2° C./minute, frequency: 5 Hz, nitrogen atmosphere. The peak value of tan δ was taken as the glass transition temperature.
Imidisation ratio

The imidisation ratio was calculated by measuring the intensity ratio of a specific absorption peak of the imide group (1775 cm⁻¹) and the absorption peak of the aromatic ring (1519 cm⁻¹) by Fourier transform infrared spectroscopy (FT-IR).

### <Polyimide 1>

Polyimide 1 contains paraphenylenediamine, 1,3-bis(4-aminophenoxy)benzene, pyromellitic dianhydride, and 3,3′,4,4′-biphenyltetracarboxylic dianhydride as constituent components, and the molar ratio of these components is paraphenylenediamine 40 mol %/1,3-bis(4-aminophenoxy)benzene 60 mol %/pyromellitic dianhydride 45 mol %/3, 3′,4,4′-biphenyltetracarboxylic dianhydride 55 mol %.

### <Polyimide 2>

Polyimide 2 contains 4,4′-diaminodiphenyl ether and pyromellitic dianhydride as constituent components, and the molar ratio of these components is 4,4′-diaminodiphenyl ether 100 mol %/pyromellitic dianhydride 100 mol %.

### Example 1

An N,N-dimethylacetamide slurry of calcium hydrogen phosphate (average particle diameter of 0.87 μm, proportion of particles having a particle diameter of 0.5 to 2.5 μm: 81.5 vol % of all particles, d₅₀: 2 μm) was added to a polyamic acid solution having the composition of Polyimide 1 such that the proportion of calcium hydrogen phosphate in the polyimide (film) was 0.12 mass %, and the mixture was sufficiently stirred and dispersed to obtain a polyamic acid solution containing inorganic particles [a solution of 3,000 poise (solid content: 20 wt %)]. The resulting polyamic acid solution was cooled to −5° C., then mixed with 1.34 mol of dried DMAc per polyamic acid unit, 3.94 mol of acetic anhydride, and 3.78 mol of β-picoline, and the mixture was extruded from a T-die having a die slit width of 1.3 mm and cast onto a rotating metal support at 73° C. to obtain a gel film having self-supporting properties. This gel film was continuously peeled from the metal support and conveyed by rollers in a room at 70° C. whilst being drawn 1.25 times in the longitudinal direction of the film. While pressing both edges of the gel film with rollers, the gel film was fixed by continuously piercing it onto a pin plate on a chain, and the edge portions of the gel film were dried and fixed first by blowing air at 250° C. onto the pin plates for 10 to 15 seconds. The gel film having both edges fixed by pins on a pin plate was drawn 1.54 times in the width direction, then dried by blowing air at 250° C. for approximately 50 seconds in a tenter, followed by heat treatment for approximately 80 seconds by employing an electric heater until the film surface temperature reached 410° C., after which it was cooled to room temperature while being allowed to relax. The film edge portions were then removed from the pins and the film edge portions were trimmed, yielding a roll of polyimide film having a width of 2,290 mm, a thickness of 25 μm, and a length of 12,600 m (water absorption rate: 0.9%, T_{g}: 247° C., imidisation ratio: 99.9%).

A bundle of polyimide fibres was obtained by applying a blade to the resulting roll of polyimide film while it was being rotated. Polyimide fibres (short fibres) having an average fibre length of 2.3 mm and an average fibre diameter of 50 μm were obtained by cutting the resulting bundle of polyimide fibres. An amount of 3.915 g of the resulting polyimide fibres, 0.81 g of polyvinyl alcohol as a fibrous binder (product number: VPB105-1, manufactured by Kuraray Co., Ltd.), 1.6 L of water, and 3 mL of a 3 mass % aqueous solution of a dispersant (product number: Texanol PE-10F, manufactured by Yoshimura Oil Chemical Co., Ltd.) were added to a mixer and stirred. Subsequently, 3 mL of a 3 mass % aqueous solution of a defoamer (product number: Home Touch 100K2, manufactured by Nikko Kagaku Co., Ltd.) was added and the mixture was further stirred. The mixture was then transferred to a 5 L graduated container and water was added to bring the volume to 5 L. A further 200 ml of a 300 ppm aqueous solution of a thickener (product number: Pamol, manufactured by Meisei Chemical Co., Ltd.) was added and stirred to obtain a slurry.

A lid was attached to the paper making frame of a TAPPI paper making machine, and 5 L of water was stored. The resulting slurry was poured into it to make paper, and then dewatering was performed. The lid of the machine was then removed, absorbent paper was placed on the resulting sheet, and a roller was placed on top and moved back and forth to absorb water. After water absorption, a press dryer was used to further absorb water. The sheet was then dried in a drum dryer with the drum surface temperature set to 115° C.

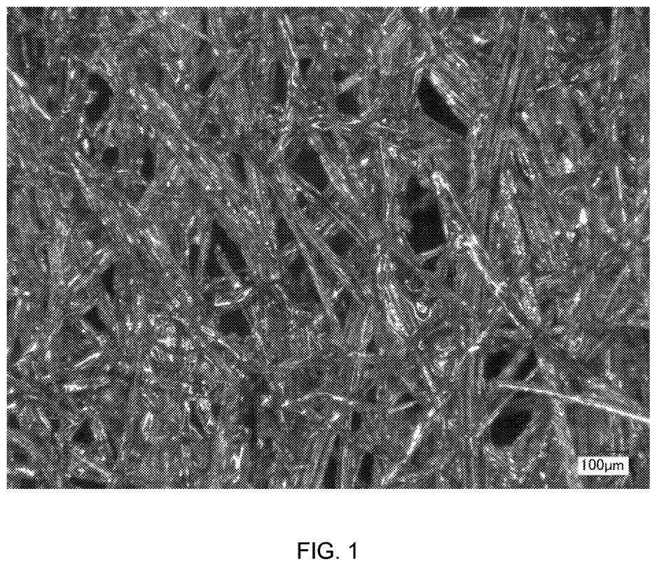

The dried sheet was impregnated with the polyamic acid precursor aqueous solution. Employed as the polyamic acid precursor aqueous solution was a 2 mass % aqueous solution of SC-1901, prepared by mixing SC-1901 (MP Gokyo Food & Chemical; containing 20 mass % of a polyamic acid having a composition of 4,4′-diaminodiphenyl ether: pyromellitic dianhydride=100:100), N,N-dimethylaminoethanol, triethyl orthoformate, and ion-exchanged water. After impregnation, the sheet was heated at 110° C. for 3 minutes to obtain temporary-bonding paper. The resulting temporary-bonding paper was heated at 440° C. for 5 minutes in a low-oxygen heating oven (inert oven) to obtain a polyimide fibre paper (FIG. 1). This polyimide fibre paper was ochre in colour. Note that in the resulting polyimide fibre paper, the content of polyimide fibres was 67 mass % and the content of polyimide resin derived from SC-1901 was 33 mass %.

### Example 2

A polyimide fibre paper obtained according to the same procedure as in Example 1 was pressed at a pressure of 10.4 MPa for 10 minutes to obtain a thinned polyimide fibre paper. This polyimide fibre paper was ochre in colour.

### Comparative Example 1

A polyimide fibre paper was obtained according to the same procedure as in Example 1, except that Polyimide 2 was used in place of Polyimide 1. This polyimide fibre paper was ochre in colour. Note that the polyimide film used had a water absorption rate of 2.3%, T_{g} of 388° C., and an imidisation ratio of 99.9%.

### Comparative Example 2

A polyimide fibre paper was obtained by heating in air the polyimide temporary-bonding paper obtained according to the same procedure as in Comparative Example 1 in an oven set at 420° C. for 6 minutes. The resulting polyimide fibre paper was ochre in colour.

TABLE 1

| | | | | | | Dielectric | |
|---|---|---|---|---|---|---|---|
| | | | | | Relative | loss | |
| | | Tensile | Tensile | Thermal | permittivity | tangent | |
| | Thickness | strength | modulus | conductivity | @ 10 | @ 10 | Porosity |
| | [mm] | [MPa] | [GPa] | [W/m · K] | GHz | GHz | [%] |
| Example 1 | 0.55 | 0.129 | 0.37 | 0.024 | 1.3 | 0.0068 | 87 |
| Example 2 | 0.37 | 0.148 | 0.25 | 0.015 | 1.4 | 0.0048 | 83 |
| Comparative | 0.54 | 0.132 | 0.30 | 0.037 | 1.3 | 0.0132 | 87 |
| Example 1 | | | | | | | |
| Comparative | 0.37 | 0.154 | 0.20 | 0.019 | 1.4 | 0.0104 | 83 |
| Example 2 | | | | | | | |

As shown in Table 1, the polyimide fibre papers of Examples 1 and 2 had a low dielectric loss tangent and thermal conductivity. The polyimide fibre papers of Examples 1 and 2 also had high tensile strength and tensile modulus. It was unexpected that Examples 1 and 2 would have low thermal conductivity and lower dielectric loss tangents, despite Example 1 and Comparative Example 1 and Example 2 and Comparative Example 2 having the same porosity.

### INDUSTRIAL APPLICABILITY

The polyimide fibre paper of the present invention is useful in applications such as thermal insulation materials for power devices and the like, thermal management materials in electronic equipment, and the like.

What is claimed is:

1. A polyimide fibre paper comprising a polyimide and having a dielectric loss tangent at 10 GHz of 0.008 or less.

2. The polyimide fibre paper of claim 1, wherein the polyimide comprises 1,3-bis(4-aminophenoxy)benzene as a polymerisation component.

3. The polyimide fibre paper of claim 2, wherein a proportion of 1,3-bis(4-aminophenoxy)benzene is 50 mol % or more based on a total diamine content of the polyimide.

4. The polyimide fibre paper of claim 2, further comprising paraphenylenediamine as a polymerisation component.

5. The polyimide fibre paper of claim 4, further comprising an aromatic acid anhydride component selected from pyromellitic dianhydride, 3,3′,4,4′-biphenyltetracarboxylic dianhydride, and mixtures thereof.

6. The polyimide fibre paper of claim 1, wherein a polyimide fibre is bound by a polyimide resin.

7. The polyimide fibre paper of claim 6, comprising 15 to 35 parts by mass of the polyimide resin relative to 100 parts by mass of the total of the polyimide fibre and polyimide resin.

8. The polyimide fibre paper of claim 1, wherein a relative permittivity is 1.5 or less.

9. The polyimide fibre paper of claim 1, wherein a thickness is in a range of from 0.1 to 0.7 mm.

10. The polyimide fibre paper of claim 1, wherein a tensile strength is 0.1 MPa or more.

11. The polyimide fibre paper of claim 1, wherein a thermal conductivity is 0.04 W/m·K or less.

12. A polyimide fibre paper comprising a polyimide comprising 1,3-bis(4-aminophenoxy)benzene as a polymerisation component.

13. The polyimide fibre paper of claim 12, wherein a proportion of 1,3-bis(4-aminophenoxy)benzene is 50 mol % or more based on a total diamine content of the polyimide.

14. The polyimide fibre paper of claim 12, wherein the polyimide further comprises paraphenylenediamine as polymerisation components.

15. The polyimide fibre paper of claim 14, further comprising an aromatic acid anhydride component selected from pyromellitic dianhydride, 3,3′,4,4′-biphenyltetracarboxylic dianhydride, and mixtures thereof.

16. The polyimide fibre paper of claim 12, wherein a polyimide fibre is bound by a polyimide resin.

17. The polyimide fibre paper of claim 16, comprising 15 to 35 parts by mass of the polyimide resin relative to 100 parts by mass of the total of the polyimide fibre and polyimide resin.

18. The polyimide fibre paper of claim 12, wherein a relative permittivity is 1.5 or less.

19. The polyimide fibre paper of claim 12, wherein a thickness is in a range of from 0.1 to 0.7 mm.

20. The polyimide fibre paper of claim 12, wherein a tensile strength is 0.1 MPa or more.

21. The polyimide fibre paper of claim 12, wherein a thermal conductivity is 0.04 W/m·K or less.
